(19) United States
(12) Patent Application Publication
(10) Pub. No.: US 2014/0295978 A1
(43) Pub. Date: Oct. 2, 2014

(54) INSERT FOR SHEAR-TYPE FLEXIBLE SHAFT COUPLINGS

(71) Applicant: FREDERIK JAN LOUWERSHEIMER, LAKELAND, FL (US)

(72) Inventor: FREDERIK JAN LOUWERSHEIMER, LAKELAND, FL (US)

(21) Appl. No.: 13/850,369

(22) Filed: Mar. 26, 2013

(51) Int. Cl. F16D 3/74

(52) U.S. Cl. CPC F16D 3/74
USPC 464/87

(57) ABSTRACT

A non-split, unitary insert for a shear-type flexible shaft coupling is provided. The insert has an inner ring and an outer ring that is non-removably joined to and encircles the inner ring. The inner ring is constructed of a material having a durometer that is less than the durometer of the material forming the outer ring. In embodiments both of these materials are polyurethane. This arrangement permits slots of the inner ring to shear while retaining the integrity of insert by preventing destruction of the outer ring during shear of the slots. The outer ring may include one or more radial tabs that are received by corresponding one or more radial notches in the inner ring to prevent separation of the rings under load.

### FIELD OF THE INVENTION

The present invention relates generally to shear-type shaft couplings having opposing hubs that are connected by a destructible insert, and more particularly, relating to an insert member of a unitary construction having a destructible inner ring and a non-destructible outer ring that is non-removably conjoined with the inner ring.

### BACKGROUND OF THE INVENTION

Flexible shaft couplings are used to transmit rotational power between a driving shaft connected to a prime mover and a driven shaft connected to a load. The flexible coupling allows for both radial and axial misalignment of the two shafts. One conventional flexible coupling, to which the present invention is directed, includes a pair of hubs, an elastomeric belt-like insert that is disposed between and connects the hubs, and a retaining ring that encircles the insert. The hubs have teeth extending axially from generally confronting hub faces that are received in slots of the centrally disposed insert so that the torque or rotational power of the driving shaft is transmitted through the insert and to the driven shaft. The retaining ring operates to prevent unwrapping of the insert from the hubs during operation. The insert also operates to shear or act as a fuse to prevent equipment damage in the event of torque overloads.

While the existing couplings including the belt-like insert and the separate retaining ring meet their respective objectives and requirements, there exists a need for an improved insert that is particularly configured for OEM application lowers initial equipment costs by simplifying assembly and reducing original part costs. Specifically, a conventional coupling including the belt-like insert and separate retaining ring are ideal for replacing an insert on in-service equipment where the shafts are not easily moved toward and away from one another. And in such circumstances the cost of the insert and retaining ring are generally quickly over shadowed by the service costs to move the shafts. But during original equipment manufacture the need to use an expensive multi-piece insert assembly including the belt-like insert and the separate retaining ring is not required because the shafts are easily moveable. Thus there is a desire in OEM to have a lower cost original insert that performs at least as high as the conventional multi-part inserts.

### SUMMARY OF THE INVENTION

Embodiments of the present invention addresses this need by providing a new insert for shear-type shaft couplings that has a unitary construction, that parallels or exceeds the performance of existing conventional inserts, and is less expensive than conventional inserts.

In general, in one aspect, a unitary, non-split insert for a shear-type shaft coupling is provided. The insert has an inner ring having a plurality of longitudinal slots, and an outer ring. The inner ring is comprised of a first material that has first durometer and the outer ring is comprised of a second material that has second durometer that is greater than said first durometer. The outer ring encircles the inner ring and is non-removably conjoined with the inner ring.

In general, in another aspect, a unitary insert for a shear-type shaft coupling is provided. The insert includes an inner ring having a plurality of longitudinal slots and at least one radial notch, and an outer ring having at least one on radial tab. The inner ring is comprised of a first material having a first durometer and the outer ring is comprised of a second material having a second durometer that is greater than the first durometer. The outer ring is over molded and encircles the inner ring with the at least one radial tab dispose within the at least one radial notch.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is an exploded perspective view of a conventional shear-type shaft coupling illustrating a split, belt-like insert and a separate retaining ring:

FIG. 2 is an exploded perspective view of a non-split, unitary insert constructed in accordance with the principles of an embodiment of the present invention and for use in connection with shear-type shaft coupling;

FIG. 3 is a front elevation view of the non-split, unitary insert; and

FIG. 4 is a partial and enlarged cross-sectional view the non-split, unitary insert taken along line 4-4 in FIG. 3.

### DETAILED DESCRIPTION OF THE INVENTION

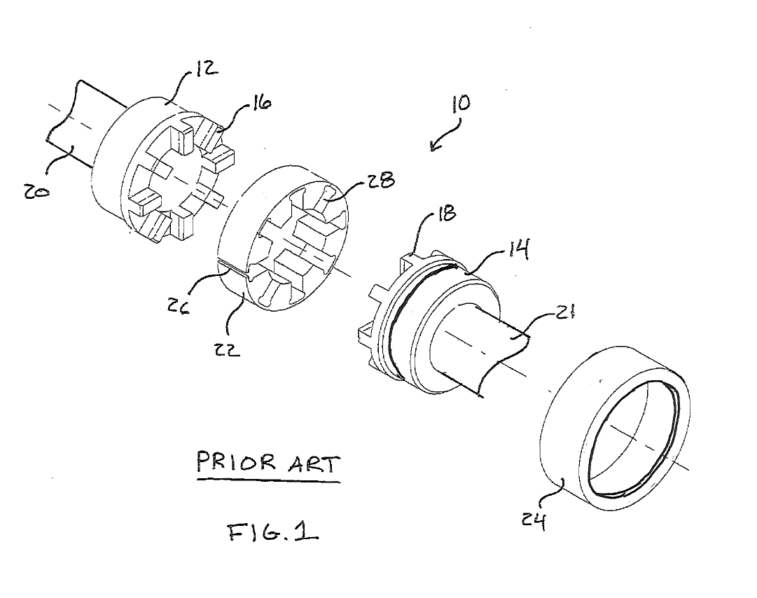

With reference to FIG. 1 there is illustrated an exploded perspective view of a typical toothed shear-type coupling 10. The coupling conventionally has two cylindrical shaft hubs 12 and 14, an insert 22, and a retaining ring 24. Each hub 12 and 14 has a plurality of radial hub teeth 16 and 18, respectively. Hub 12 is mounted to a driving shaft 20 and hub 14 is mounted to a driven shaft 21. Insert 22 includes a radial slit 26 and plurality of axially extending slots 28. The slit 26 permits the insert to be unwrapped or opened and then wrapped around the hub teeth 16 and 18, positioning the teeth within a corresponding slot 28, connecting hubs 12 and 14 together. Retaining ring 24 encircles insert 22 to prevent radial expansion or unwrapping of the insert when the coupling is under load and from rotation. Retaining ring 24 is secured in place by a spring-clip (not shown).

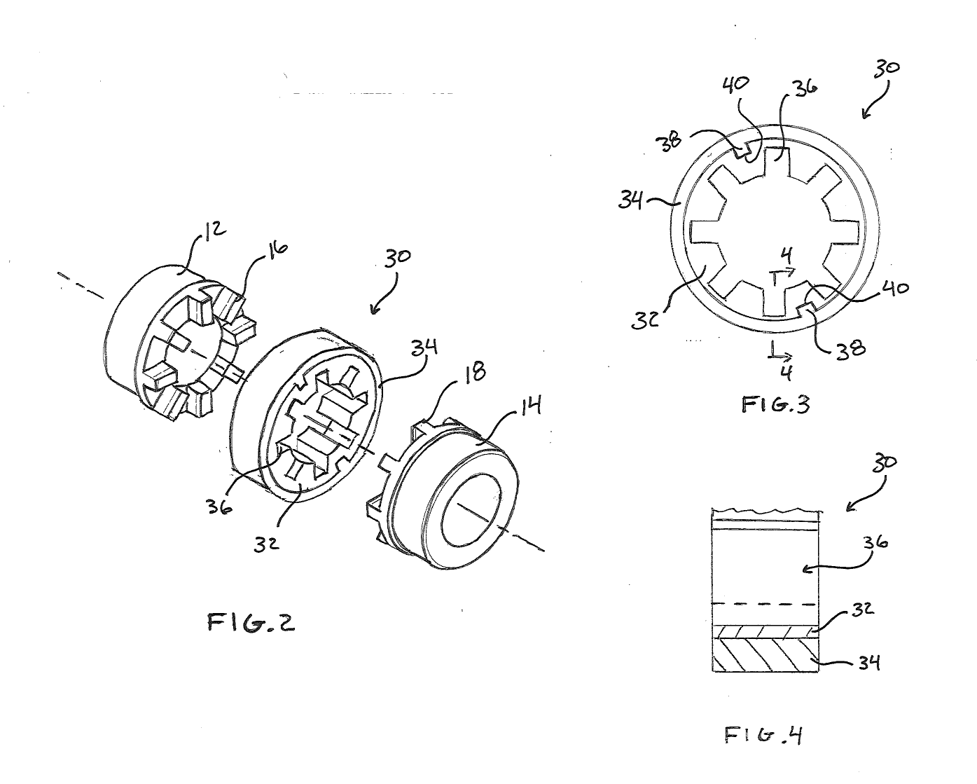

With reference to FIGS. 2 through 4, there is illustrated a new insert 30 constructed in accordance with an embodiment of the present invention. Insert 30 includes an inner ring 32 and an outer ring 34. Similar to conventional inserts, such as insert 22 described in connection with FIG. 1, the inner ring 32 includes longitudinal slots 36 that are arranged to correspond with and to receive teeth 16 and 18 of hubs 12 and 14, respectively, to connect the hubs. However, insert 30 is not split, such as by slit 26 of insert 22, and thus is not wrapped around the hubs 12 and 14 like a belt. Rather, hubs 12 and 14 are moved axially relative to insert 30 to position teeth 16, 18 within corresponding slots 36 to connect the hubs.

Continuing with reference to FIGS. 2 through 4, the outer ring 34 encircles the inner ring 32 and is non-removably conjoined to the inner ring such that it cannot be displaced axially or radially with respect to one another. In an embodiment, this joining is attained by over molding the outer ring 34 on to inner ring 32. To further prevent relative movement, and particularly, to prevent the inner ring 32 from detaching from and spinning within the outer ring, the outer ring may include one or more tabs 38 extending radially inward that are disposed within one or more corresponding notches 40 in the inner ring. Of course tabs 38 and notches 40 could be reversed and the tabs could extend from the inner ring 32 and with the notches 40 in the outer ring 34. Tab 38 pairs are arranged to be diametrically opposite one another to more evenly distribute force loading.

The inner ring 32 is comprised of a material having a first durometer and the outer ring 34 is comprised of a material having a second durometer that is greater than the inner ring. This arrangement permits slots 36 of the inner ring 32 to shear while retaining the integrity of insert 30 by preventing destruction of the outer ring 34 during shear of the slots. In an embodiment, the material comprising the inner ring 32 has a durometer of 95A and the material comprising the outer ring 34 has a durometer of 75D.

As discussed above and in an embodiment, insert 30 may be formed by over molding the outer ring 34 on the inner ring 32. In such a manufacture it is contemplated that the inner ring 32 will first be molded of a first material and allowed to either partially or fully cure prior to over molding the inner ring 32 with a second material to form the outer ring 34. It is also contemplated that a bonding agent may be applied to the circumference of the inner ring 32 prior to over molding with the second material to form the outer ring 34. Application of the bonding agent further increases the joining of the outer and inner rings 32 and 34. In embodiments, the second material shrinks when it cures causing the outer ring 34 to inwardly compress against the inner ring 32. This inward compression by the outer ring 34 against the inner ring 32 also prevents the rings from separating. The first and second material may be polyurethane. The use of polyurethane for at least the material comprising the outer ring 34 will provide the inward compression by the outer ring against the inner ring 32. Other materials may also provide the desired compression.

Inserts 30 in accordance with the present invention should not be limited to manufacture by over molding. Other methods of manufacture may remain within the scope of the invention. For example, while it has not been specifically attempted, it may be possible to manufacture insert 30 by an extrusion processes, such as, for example, a co-extrusion process. Thus the invention should not be limited to a particular mode of manufacture unless otherwise specified, for example, in the following claims.

A number of embodiments of the present invention have been described. Nevertheless, it will be understood that various modifications may be made without departing from the spirit and scope of the invention. Accordingly, other embodiments are within the scope of the following claims.

What is claimed is:

1. A unitary insert for a shear-type shaft coupling, the insert comprising:
an inner ring comprised of a first material of a first durometer and having a plurality of longitudinal slots;
an outer ring comprised of a second material of a second durometer that is greater than said first durometer;
said outer ring encircling said inner ring and being non-removably conjoined therewith; and
said insert is not radially split.

2. The unitary insert of claim 1, wherein said outer ring is over molded said inner ring.

3. The unitary insert of claim 2, wherein said outer ring inwardly compresses against said inner ring.

4. The insert of claim 1, wherein said second durometer is greater than the first durometer such that a radial shearing of said inner ring does not cause a substantial radial shearing of said outer ring.

5. The insert of claim 4, wherein said first material and said second material is polyurethane.

6. The insert of claim 1, wherein said inner ring and said outer ring are joined such that said inner ring and said outer ring cannot be displaced relative to one another without destruction of either of said inner ring or said outer ring.

7. The insert of claim 1, wherein said first material and said second material is polyurethane.

8. A unitary insert for a shear-type shaft coupling, the insert comprising:
an inner ring comprised of a first material of a first durometer and having a plurality of longitudinal slots and at least one radial notch;
an outer ring comprised of a second material of a second durometer and having at least one radial tab, said outer ring over molded and encircling said inner ring with said at least one radial tab disposed within said at least one radial notch; and
said insert is not radially split.

9. The insert of claim 8, wherein said first material and said second material is polyurethane.

10. The insert of claim 9, wherein said second durometer is greater than the first durometer such that a radial shearing of said inner ring does not cause a substantial radial shearing of said outer ring.

11. The insert of claim 8, wherein said outer ring entirely encircles said inner ring.
